(19) United States
(12) Patent Application Publication
(10) Pub. No.: US 2022/0349992 A1
(43) Pub. Date: Nov. 3, 2022

(54) RADAR DEVICE

(71) Applicant: Mitsubishi Electric Corporation, Tokyo (JP)

(72) Inventors: Koji TSUTSUMI, Tokyo (JP); Sho IKEDA, Tokyo (JP)

(73) Assignee: Mitsubishi Electric Corporation, Tokyo (JP)

(21) Appl. No.: 17/866,809

(22) Filed: Jul. 18, 2022

Related U.S. Application Data
(63) Continuation of application No. PCT/JP2020/011119, filed on Mar. 13, 2020.

(51) Int. Cl. G01S 7/35; G01S 13/89

(52) U.S. Cl. CPC G01S 7/352; G01S 13/89

(57) ABSTRACT

In a radar device, a reception antenna directly receives a chirp signal transmitted by a transmission antenna of a module other than a module to which the reception antenna belongs among a plurality of modules, a mixer generates a baseband signal by mixing a chirp signal generated by a chirp signal source and a chirp signal received by the reception antenna, and an analog-to-digital converter generates a digital signal by digital-converting the baseband signal generated by the mixer.

### CROSS REFERENCE TO RELATED APPLICATIONS

This application is a Continuation of PCT International Application No. PCT/JP2020/011119, filed on Mar. 13, 2020, which is hereby expressly incorporated by reference into the present application.

### TECHNICAL FIELD

The present disclosure relates to a radar device.

### BACKGROUND ART

A radar device emits a radio wave from a transmission antenna to a target, receives a reflected wave reflected by the target by a reception antenna, and processes a received signal to measure a distance, an azimuth direction, a relative speed, or the like to the target. In a configuration in which a radar device includes a plurality of antennas, in order to accurately measure a distance, an azimuth direction, a relative speed, or the like, it is necessary to consider a phase difference of a signal between antennas caused by a time difference between an output start timing of a signal in one antenna and an output start timing of a signal in the other antenna, a path difference between a signal path in one antenna and a signal path in the other antenna, or the like. Note that examples of the “signal path in the antenna” here include a path from when a signal is output from a signal source to when the signal is transmitted by a transmission antenna, a path from when a signal is received by a reception antenna to when the signal is mixed with a mixing signal by a mixer, and the like.

For example, Patent Literature 1 discloses a method for detecting a phase difference of a signal between antennas by transmitting a signal from one antenna and receiving a reflected wave reflected by a reflector by the other antenna in a radar device including a plurality of antennas.

### CITATION LIST

### Patent Literature

Patent Literature 1: JP 2006-10404 A

### SUMMARY OF INVENTION

### Technical Problem

In the method of Patent Literature 1, it is necessary to prepare a reflector that reflects the radio wave transmitted by the transmission antenna toward the reception antenna, and there is a problem that there is a large limitation in detecting the phase difference of the signal between the antennas while the radar device is operating.

The present disclosure has been made to solve the above problem, and an object of the present disclosure is to provide a technique for detecting a phase difference of a signal between antennas without preparing a reflector.

### Solution to Problem

A radar device according to the present disclosure is a radar device including a plurality of modules, each of the plurality of modules including a chirp signal source, a transmission antenna, a reception antenna, a mixer, and an analog-to-digital converter, wherein the chirp signal source generates a chirp signal, the transmission antenna transmits the chirp signal generated by the chirp signal source, the reception antenna directly receives chirp signals transmitted by transmission antennas of modules other than a module to which the reception antenna belongs among the plurality of modules, the mixer generates a baseband signal by mixing the chirp signal generated by the chirp signal source and the chirp signals received by the reception antenna, and the analog-to-digital converter generates a digital signal by digital-converting the baseband signal generated by the mixer, further comprising a chirp signal controller to perform control so that the chirp signal sources of the plurality of modules generate chirp signals each having a chirp start timing different from each other: and a phase difference detector to identify a module of a signal source of a chirp signal on which a digital signal generated by the analog-to-digital converter is based, by detecting a frequency difference of the chirp signal between modules, the frequency difference being generated by the control by the chirp signal controller, on a basis of the digital signal.

A radar device according to the present disclosure comprises a plurality of modules, each of the plurality of modules including a chirp signal source, a transmission antenna, a reception antenna, a mixer, and an analog-to-digital converter, wherein the chirp signal source generates a chirp signal, the transmission antenna transmits the chirp signal generated by the chirp signal source, the reception antenna directly receives chirp signals transmitted by transmission antennas of modules other than a module to which the reception antenna belongs among the plurality of modules, the mixer generates a baseband signal by mixing the chirp signal generated by the chirp signal source and the chirp signals received by the reception antenna, and the analog-to-digital converter generates a digital signal by digital-converting the baseband signal generated by the mixer, wherein the chirp signal source includes a transmission chirp signal source to generate a transmission chirp signal and a mixing chirp signal source to generate a mixing chirp signal, the transmission antenna transmits the transmission chirp signal generated by the transmission chirp signal source, the reception antenna directly receives transmission chirp signals transmitted by transmission antennas of modules other than a module to which the reception antenna belongs among the plurality of modules, and the mixer generates a baseband signal by mixing the mixing chirp signal generated by the mixing chirp signal source and the transmission chirp signals received by the reception antenna.

### ADVANTAGEOUS EFFECTS OF INVENTION

According to the present disclosure, it is possible to detect a phase difference of a signal between antennas without preparing a reflector.

### BRIEF DESCRIPTION OF DRAWINGS

FIG. 1 is a block diagram showing a configuration of a radar device according to a first embodiment.

FIG. 2A is a graph illustrating a chirp waveform generated by each chirp signal source of four modules. FIG. 2B is an enlarged view of the graph of FIG. 2A.

FIGS. 3A, 3B, 3C, and 3D are graphs each illustrating frequency spectrums of beat signals generated by a mixer in a specific example of the first embodiment.

FIG. 4 illustrates an example of a delay time of a chirp signal generation start timing by each chirp signal source in a case where the number of modules included in the radar device according to the first embodiment takes various values.

FIG. 5A is a graph illustrating a chirp waveform generated by each chirp signal source of four modules according to a modification of the first embodiment. FIG. 5B is an enlarged view of the graph of FIG. 5A.

FIGS. 6A, 6B, 6C, and 6D are graphs illustrating spectrums of beat signals in the modification of the first embodiment.

FIG. 7 is a block diagram showing a configuration of a radar device according to a second embodiment.

FIG. 8A is a graph illustrating a chirp waveform generated by each chirp signal source of four modules. FIG. 8B is an enlarged view of the graph of FIG. 8A.

FIG. 9 is a graph illustrating a frequency spectrum of a beat signal generated by a mixer of each module in a specific example of the second embodiment.

FIG. 10A is a graph illustrating a chirp waveform generated by each chirp signal source of four modules according to a modification of the second embodiment. FIG. 10B is an enlarged view of the graph of FIG. 10A.

FIG. 11 is a graph showing a frequency spectrum of a beat signal generated by a mixer of each module in a modification of the second embodiment.

FIG. 12A is a graph illustrating a chirp waveform generated by each chirp signal source of four modules according to another modification of the second embodiment. FIG. 12B is an enlarged view of the graph of FIG. 12A.

FIG. 13 is a graph showing a frequency spectrum of a beat signal generated by a mixer of each module in the other modification of the second embodiment.

FIG. 14 is a block diagram showing a configuration of a radar device according to a third embodiment.

FIG. 15A is a graph illustrating a chirp waveform generated by each chirp signal source of four modules according to a specific example of the third embodiment. FIG. 15B is an enlarged view of the graph of FIG. 15A.

FIG. 16 is a graph illustrating a spectrum of a beat signal generated by a mixer of a second module according to the specific example of the third embodiment.

FIG. 17A is a block diagram showing a hardware configuration for implementing functions of the radar device according to each embodiment. FIG. 17B is a block diagram showing a hardware configuration for executing software that implements functions of the radar device according to each embodiment.

### DESCRIPTION OF EMBODIMENTS

For example, in an in-vehicle radar device, a frequency-modulated chirp signal is used as a transmission chirp signal, the same chirp signal as the transmission chirp signal is used as a mixing chirp signal, a beat signal is generated by mixing the mixing chirp signal and a received chirp signal, and a distance to a target or the like is calculated on the basis of the beat signal.

Since the in-vehicle radar device includes a plurality of transmission antennas and reception antennas or a plurality of transmission and reception antennas, as a result, an effect similar to the effect obtained by increasing the aperture size of the antenna can be obtained, and the angular resolution with respect to the target can be increased. However, in that case, as described above, it is necessary to consider the phase difference of the signal between the antennas. Then, in a case where a variation occurs in the phase difference of the signal between the antennas due to a manufacturing variation, a secular change, a temperature change, or the like, it is necessary to correct the variation.

Furthermore, in a case where the distance between the transmission antenna and the reception antenna is large, a configuration using a signal source different from the chirp signal source for transmission as the above-described chirp signal source for mixing is also conceivable. However, in that case, when a variation occurs in the output phase difference between the chirp signal source for transmission and the chirp signal source for mixing, it is necessary to perform the correction. In addition, the phase relationship between each output signals of the plurality of chirp signal sources can be obtained by, for example, wired measurement for each module or calibration with a reference target, but phase characteristics may fluctuate due to aging deterioration, temperature fluctuation, power supply voltage fluctuation, or the like of the radar device, and it is important to constantly observe the phase fluctuation.

In order to explain the present disclosure in more detail, embodiments for carrying out the present disclosure will be described below with reference to the accompanying drawings.

### First Embodiment

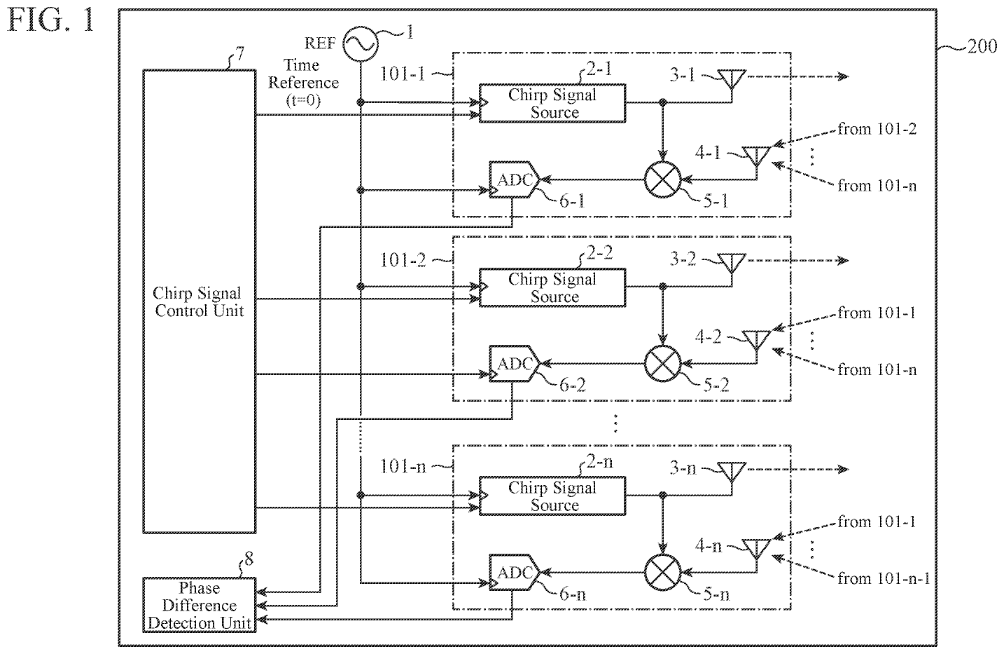

FIG. 1 is a block diagram showing a configuration of a radar device 200 according to a first embodiment. As illustrated in FIG. 1, the radar device 200 includes a REF 1 (reference clock generation unit), n modules (a plurality of modules) including a first module 101-1 and a second module 101-2, a chirp signal control unit 7, and a phase difference detection unit 8. In the present specification, n is a positive integer of 2 or more.

The REF 1 is a circuit that generates a reference clock that synchronizes all signal sources generated in the radar device 200. The REF 1 outputs the generated reference clock to each of the n modules.

Each of the n modules includes a chirp signal source, a transmission antenna, a reception antenna, a mixer, and an analog-to-digital converter. Since each of the n modules has a similar configuration, a chirp signal source 2-1, a transmission antenna 3-1, a reception antenna 4-1, a mixer 5-1, and an analog-to-digital converter 6-1 (in the figure, ADC) included in the first module 101-1 will be representatively described below. Similarly to the first module 101-1, the second module 101-2 also includes a chirp signal source 2-2, a transmission antenna 3-2, a reception antenna 4-2, a mixer 5-2, and an analog-to-digital converter 6-2.

The chirp signal source 2-1 (chirp signal generation unit) generates a chirp signal. More specifically, in the first embodiment, the chirp signal source 2-1 generates a chirp signal in synchronization with the reference signal. That is, each chirp signal source of the n modules generates a chirp signal in synchronization with the reference signal.

More specifically, in the first embodiment, the chirp signal source 2-1 generates a chirp signal under the control of the chirp signal control unit 7. The chirp signal source 2-1 outputs the generated chirp signal to each of the transmission antenna 3-1 and the mixer 5-1.

The transmission antenna 3-1 transmits the chirp signal generated by the chirp signal source 2-1. More specifically, the transmission antenna 3-1 transmits the chirp signal generated by the chirp signal source 2-1 as a radio wave. More specifically, the transmission antenna 3-1 transmits the chirp signal generated by the chirp signal source 2-1 to each reception antenna of the n modules as a radio wave. For example, the transmission antenna 3-1 transmits the chirp signal as a radio wave toward a range in which each reception antenna of the n modules can receive the transmitted chirp signal.

Note that, in the first embodiment, the configuration in which the chirp signal source 2-1 and the transmission antenna 3-1 are directly connected is described, but for example, a frequency multiplier, a mixer, or the like may be provided between the chirp signal source 2-1 and the transmission antenna 3-1. In this case, the chirp signal generated by the chirp signal source 2-1 is frequency-converted by a frequency multiplier, a mixer, or the like, and then transmitted by the transmission antenna 3-1.

The reception antenna 4-1 directly receives chirp signals transmitted by transmission antennas of modules other than a module to which the reception antenna 4-1 belongs among the n modules. For example, the reception antenna 4-1 faces a direction in which it can directly receive the chirp signals transmitted by the transmission antennas of the modules other than the module to which the reception antenna 4-1 belongs. Alternatively, for example, the reception antenna 4-1 is disposed at a position where it can directly receive the chirp signals transmitted by the transmission antennas of the modules other than the module to which the reception antenna 4-1 belongs.

Here, the “the module to which the reception antenna 4-1 belongs” is the first module 101-1, and the reception antenna 4-1 directly receives the chirp signals transmitted by the transmission antennas of at least one or more modules other than the first module 101-1. Further, the reception antenna 4-1 may further directly receive the chirp signal transmitted by the transmission antenna 3-1 which is the transmission antenna of the module to which the reception antenna 4-1 belongs. The reception antenna 4-1 outputs the received chirp signals to the mixer 5-1.

The mixer 5-1 mixes the chirp signal generated by the chirp signal source 2-1 and the chirp signals received by the reception antenna 4-1 to generate a baseband signal. Note that the baseband signal here is a beat signal.

More specifically, in the first embodiment, the mixer 5-1 generates a baseband signal by down-converting the chirp signals received by the reception antenna 4-1 using the chirp signal generated by the chirp signal source 2-1. The mixer 5-1 outputs the generated baseband signal to the analog-to-digital converter 6-1.

As described above, in the first embodiment, the mixer 5-1 uses the same chirp signal as the chirp signal transmitted by the transmission antenna 3-1 as the mixing chirp signal to be mixed with the chirp signals received by the reception antenna 4-1. However, for example, the radar device 200 may further include a frequency multiplier to multiply the frequency of the chirp signal generated by the chirp signal source 2-1, the transmission antenna 3-1 may transmit the chirp signal frequency-multiplied by the frequency multiplier as the transmission chirp signal, and the mixer 5-1 may use a not frequency-multiplied chirp signal as the mixing chirp signal. In that case, the mixer 5-1 can be a harmonic mixer. As a result, the mixer 5-1 can mix the frequency-multiplied chirp signal and the not frequency-multiplied chirp signal.

The analog-to-digital converter 6-1 generates a digital signal by digital-converting the baseband signal generated by the mixer 5-1. The analog-to-digital converter 6-1 outputs the generated digital signal to the phase difference detection unit 8.

The chirp signal control unit 7 controls each chirp signal source of the n modules. More specifically, the chirp signal control unit 7 performs control so that the chirp signal sources of the n modules generate chirp signals each having at least one of a chirp start timing and a frequency different from each other. For example, the chirp signal control unit 7 varies the timing of starting the generation of the chirp signal by each chirp signal source so that the chirp signal sources of the n modules generate chirp signals having chirp start timings different from each other. Details will be described later.

The phase difference detection unit 8 detects a phase difference of the chirp signal between the modules on the basis of the digital signal generated by the analog-to-digital converter 6-1. In addition, in the first embodiment, the phase difference detection unit 8 identifies the module of the signal source of the chirp signal on which the digital signal is based by detecting the frequency difference of the chirp signal between the modules generated by the control by the chirp signal control unit 7 on the basis of the digital signal generated by the analog-to-digital converter 6-1. Details will be described later.

Note that the chirp signal control unit 7 may adjust the chirp signal generation start timing of the chirp signal source 2-1 on the basis of the phase difference detected by the phase difference detection unit 8. Although not illustrated, the radar device 200 may further have a configuration of displaying the phase difference detected by the phase difference detection unit 8 as an image.

Note that, in the first embodiment, a configuration in which the radar device 200 includes the chirp signal control unit 7 and the phase difference detection unit 8 as separate components will be described. However, the radar device 200 may include a control unit having both the function of the chirp signal control unit 7 and the function of the phase difference detection unit 8. In this case, for example, the control unit may adjust the chirp signal generation start timing of the chirp signal source 2-1 by the function of the chirp signal control unit 7 on the basis of the phase difference detected by the function of the phase difference detection unit 8.

Note that, in the present specification, the “phase difference of the chirp signal between the modules” means a phase difference between a phase of the chirp signal inside one module and a phase of the chirp signal inside the other module. The “phase difference of the chirp signal between the modules” is, for example, a phase difference caused by a time difference between an output start timing of a signal in one module and an output start timing of a signal in the other module, a phase difference caused by a path difference between a signal path in one module and a signal path in the other module, or the like.

The operation of the radar device 200 according to the first embodiment will be described below. Hereinafter, as a representative, a configuration for detecting the phase difference of the chirp signal between the first module 101-1 and the second module 101-2 is assumed. The operation described below can be generalized by setting “first” to i and setting “second” to h (i and h are positive integers).

First, the chirp signal source 2-1 of the first module 101-1 generates a chirp signal in synchronization with the reference signal. The chirp signal source 2-1 outputs the generated chirp signal to the transmission antenna 3-1. The transmission antenna 3-1 of the first module 101-1 transmits the chirp signal generated by the chirp signal source 2-1 as a radio wave toward the second module 101-2.

Meanwhile, the chirp signal source 2-2 of the second module 101-2 generates a chirp signal in synchronization with the reference signal, and outputs the generated chirp signal to the mixer 5-2. The reception antenna 4-2 of the second module 101-2 directly receives the chirp signal transmitted by the transmission antenna 3-1 of the first module 101-1.

Next, the mixer 5-2 of the second module 101-2 generates a baseband signal by mixing the chirp signal generated by the chirp signal source 2-2 and the chirp signal received by the reception antenna 4-2.

Next, the analog-to-digital converter 6-2 of the second module 101-2 generates a digital signal by digital-converting the baseband signal generated by the mixer 5-2. The analog-to-digital converter 6-2 outputs the generated digital signal to the phase difference detection unit 8.

Next, the phase difference detection unit 8 detects the phase difference of the chirp signal between the first module 101-1 and the second module 101-2 on the basis of the digital signal generated by the analog-to-digital converter 6-2.

More specifically, regarding the phase difference of the chirp signal between the first module 101-1 and the second module 101-2, for example, when the phase of the chirp signal generated by the chirp signal source 2-1 of the first module 101-1 and transmitted by the transmission antenna 3-1 is φₛ(1), the phase of the chirp signal received by the reception antenna 4-2 of the second module 101-2 is φₛ(1)+φ_{d}(2, 1). φ_{d}(2, 1) is a phase delay amount of propagation from the transmission antenna 3-1 of the first module 101-1 to the reception antenna 4-1 of the second module 101-2. Note that, here, the phase delay amount of the chirp signal due to the path from the chirp signal source 2-1 to the transmission antenna 3-1 in the first module 101-1 is ignored.

When the phase of the chirp signal generated by the chirp signal source 2-2 of the second module 101-2 is φₛ(2), the phase difference between the phase of the chirp signal generated by the chirp signal source 2-2 and the phase of the chirp signal received by the reception antenna 4-2 in the mixer 5-2 of the second module 101-2 is φₛ(1)+φ_{d}(2, 1)−φₛ(2). Here, the phase delay amount of the chirp signal between the circuits in the second module 101-2 is also ignored.

That is, assuming that φ_{d}(2, 1) is unchanged, the radar device 200 can detect the phase difference φₛ(1)−φₛ(2) between the phase of the chirp signal generated by the chirp signal source 2-1 of the first module 101-1 and the phase of the chirp signal generated by the chirp signal source 2-2 of the second module 101-2 by the phase difference detection unit 8 by observing the phase difference.

In the above description, φ_{d}(2, 1) is unchanged. However, as long as transmission and reception information of a chirp signal between n modules can be obtained, a value of φ_{d}(2, 1) can be calculated. That is, even when the distance between the modules changes, the amount of change in the distance between the modules can be detected by observing a direct wave from one module to the other module by the above method.

Here, the chirp signal received by the reception antenna 4-2 of the second module 101-2 is a signal obtained by adding the transmission signals of the plurality of other modules. Therefore, the radar device 200 needs to separate the addition signals and identify the module of the signal source. Therefore, as described above, the chirp signal control unit 7 performs control so that the chirp signal sources generate chirp signals each having at least one of a chirp start timing and a frequency different from each other. Then, each mixer mixes the chirp signal generated by the chirp signal source of the module to which it belongs and the chirp signals transmitted from the plurality of modules other than the module to which it belongs. Hereinafter, a specific example of the control by the chirp signal control unit 7 as described above will be described in more detail with reference to the drawings.

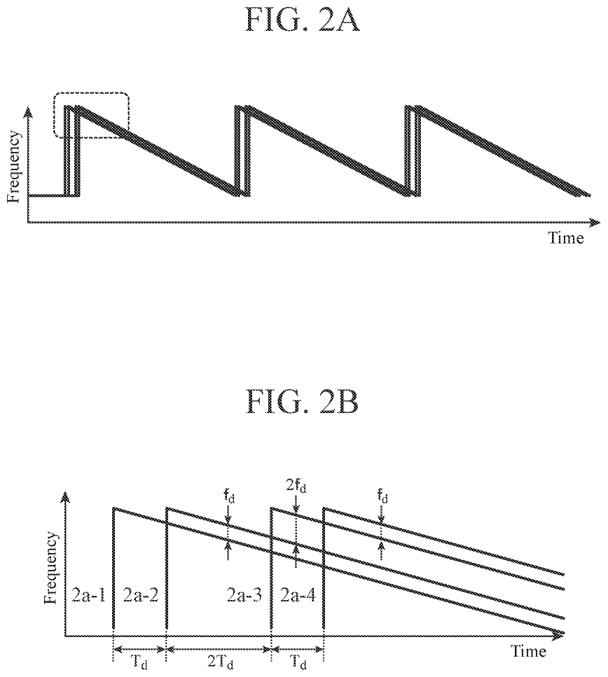

FIG. 2A is a graph illustrating a chirp waveform generated by each chirp signal source of four modules. FIG. 2B is an enlarged view of the graph (dotted line portion) in FIG. 2A. In the following description, it is assumed that the number of modules included in the radar device 200 is four (n=4). In FIGS. 2A and 2B, the vertical axis represents the frequency of each chirp signal, and the horizontal axis represents time.

In this specific example, in order to enable the reception side to separate the four chirp signals output from the four chirp signal sources, the chirp signal control unit 7 performs control so that the four chirp signal sources start generating and outputting chirp signals at different timings.

Hereinafter, the operation of the chirp signal control unit 7 according to the specific example will be described. First, as a first step, the chirp signal control unit 7 performs control so that the chirp signal source 2-1 of the first module 101-1 starts generating and outputting the chirp signal earliest among the chirp signal sources of the first module 101-1, the second module 101-2, the third module (not illustrated), and the fourth module (not illustrated).

Next, after a delay of a time T_{d} after the chirp signal source 2-1 of the first module 101-1 starts generating the chirp signal, the chirp signal control unit 7 performs, as a second step, control so that the chirp signal source 2-2 of the second module 101-2 starts generating and outputting a chirp signal having the same parameter as the parameter of the chirp signal generated by the chirp signal source 2-1 of the first module 101-1. Next, after a delay of a time 2 T_{d} after the chirp signal source 2-2 of the second module 101-2 starts generating the chirp signal, the chirp signal control unit 7 performs, as a third step, control so that the chirp signal source of the third module starts generating and outputting a chirp signal having the same parameter as the parameter of the chirp signal generated by the chirp signal source 2-1 of the first module 101-1.

Next, after a delay of a time T_{d} after the chirp signal source of the third module starts generating the chirp signal, the chirp signal control unit 7 performs, as a fourth step, control so that the chirp signal source of the fourth module starts generating and outputting a chirp signal having the same parameter as the parameter of the chirp signal generated by the chirp signal source 2-1 of the first module 101-1.

As a result, as illustrated in FIGS. 2A and 2B, the chirp start timing of each chirp signal is shifted.

The starting frequencies of the chirp signals output from each chirp signal sources are the same, and the frequency change rates (α) of the chirp signals output from each chirp signal sources are the same. Therefore, when the output start time of the chirp signal is shifted by T_{d}, the frequency is shifted by f_{d}=α×T_{d}. More specifically, the frequency difference between the frequency of the chirp signal output from the chirp signal source 2-1 of the first module 101-1 and the frequency of the chirp signal output from the chirp signal source 2-2 of the second module 101-2 is f_{d}. The frequency difference between the frequency of the chirp signal output from the chirp signal source 2-2 of the second module 101-2 and the frequency of the chirp signal output from the chirp signal source of the third module is 2 f_{d}. The frequency difference between the frequency of the chirp signal output from the chirp signal source of the third module and the frequency of the chirp signal output from the chirp signal source of the fourth module is f_{d}.

The chirp signal generated by each chirp signal source as described above is processed as follows. For example, the transmission antenna 3-2 of the second module 101-2 transmits the chirp signal output by the chirp signal source 2-2 of the second module 101-2, the transmission antenna of the third module transmits the chirp signal output by the chirp signal source of the third module, and the transmission antenna of the fourth module transmits the chirp signal output by the chirp signal source of the fourth module. The reception antenna 4-1 of the first module 101-1 receives the chirp signals transmitted by the transmission antenna 3-2 of the second module 101-2, the transmission antenna of the third module, and the transmission antenna of the fourth module. Next, the mixer 5-1 of the first module 101-1 generates a baseband signal by mixing the chirp signal generated by the chirp signal source 2-1 of the first module 101-1, the chirp signal received by the reception antenna 4-1 of the first module 101-1 from the transmission antenna 3-2 of the second module 101-2, the chirp signal received by the reception antenna 4-1 of the first module 101-1 from the transmission antenna of the third module, and the chirp signal received by the reception antenna 4-1 of the first module 101-1 from the transmission antenna of the fourth module.

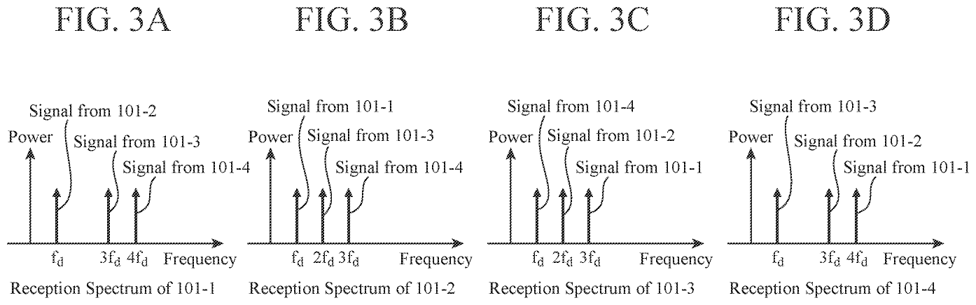

FIGS. 3A, 3B, 3C, and 3D are graphs illustrating frequency spectrums of beat signals (baseband signals) generated by the mixer in the specific example. In FIGS. 3A, 3B, 3C, and 3D, the vertical axis represents the power of the beat signal, and the horizontal axis represents the frequency of the beat signal.

More particularly, FIG. 3A is a graph showing the spectrum of a beat signal generated by the mixer 5-1 of the first module 101-1. In the first module 101-1, the reception antenna 4-1 receives the chirp signals output from the second module 101-2, the third module (although not illustrated, corresponds to 101-3), and the fourth module (although not illustrated, corresponds to 101-4), and the mixer 5-1 generates a beat signal which is a baseband signal by mixing the chirp signal generated by the chirp signal source 2-1 and the chirp signals received by the reception antenna 4-1.

For example, the spectrum of the frequency f_{d} illustrated in FIG. 3A indicates the frequency of a mixed wave (beat signal) of the chirp signal generated by the chirp signal source 2-1 of the first module 101-1 and the chirp signal received by the reception antenna 4-1 of the first module 101-1 from the transmission antenna 3-2 of the second module 101-2. Note that, here, for simplification, the propagation delay time of the radio wave between the first module 101-1 and the second module 101-2 is ignored.

Similarly, the spectrum of the frequency 3 f_{d} illustrated in FIG. 3A indicates the frequency of the mixed wave of the chirp signal generated by the chirp signal source 2-1 of the first module 101-1 and the chirp signal received by the reception antenna 4-1 of the first module 101-1 from the transmission antenna of the third module. Note that, here, for simplification, the propagation delay time of the radio wave between the first module 101-1 and the third module is ignored.

The spectrum of the frequency 4 f_{d} illustrated in FIG. 3A indicates the frequency of the mixed wave of the chirp signal generated by the chirp signal source 2-1 of the first module 101-1 and the chirp signal received by the reception antenna 4-1 of the first module 101-1 from the transmission antenna of the fourth module. Note that, here, for simplification, the propagation delay time of the radio wave between the first module 101-1 and the fourth module is ignored.

As described above, since the mixed waves derived from the chirp signals received from the three modules other than the first module 101-1 all have different frequencies, they can be easily separated by spectrum analysis, and the phase of each chirp signal can be calculated.

Similarly, FIG. 3B is a graph showing a spectrum of a beat signal generated by the mixer 5-2 of the second module 101-2. FIG. 3C is a graph illustrating a spectrum of a beat signal generated by the mixer of the third module. FIG. 3D is a graph illustrating a spectrum of a beat signal generated by the mixer of the fourth module. As illustrated in FIGS. 3B, 3C, and 3D, also in the second module 101-2, the third module, or the fourth module, the frequency of each mixed wave is shifted for each derived module, and can be easily separated.

Then, on the basis of the digital signal generated by the analog-to-digital converter 6-1, the phase difference detection unit 8 can detect the frequency difference of the chirp signal between the modules, which is caused by the control by the chirp signal control unit 7, and identify the module of the signal source of the chirp signal on which the digital signal is based from the frequency difference.

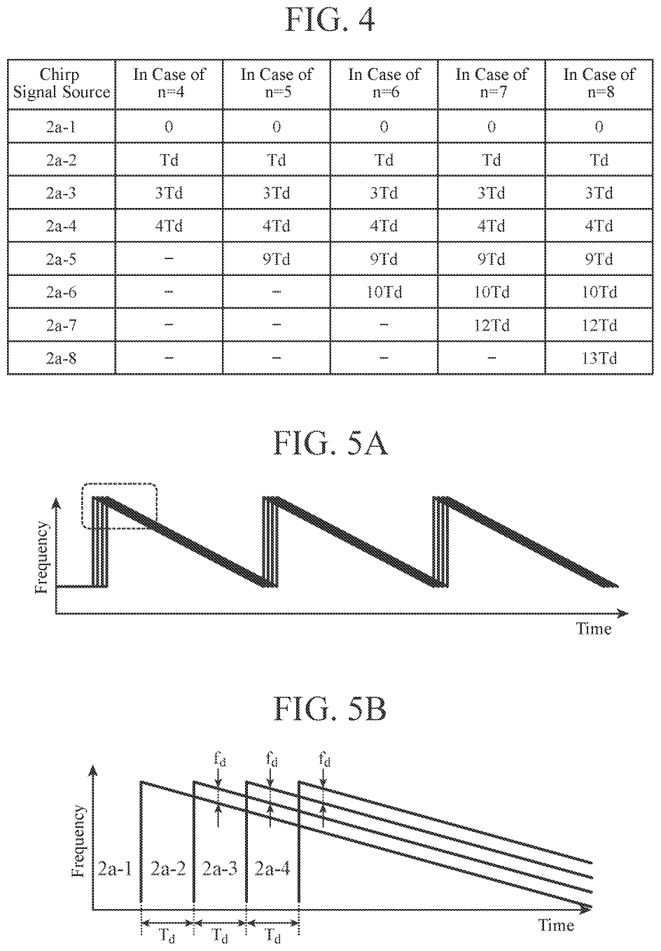

FIG. 4 illustrates an example of the delay time of the generation start timing of the chirp signal by each chirp signal source in a case where the number of modules n included in the radar device 200 takes various values. In the specific example, the control by the chirp signal control unit 7 has been described taking the case of n=4 as an example. However, as illustrated in FIG. 4, also in a case where the number of modules included in the radar device 200 is further increased, a configuration similar to the configuration of the specific example can be applied to the control by the chirp signal control unit 7.

For example, in a case of a configuration in which multiplexing of chirp signals transmitted by a plurality of modules is not performed, it is necessary to sequentially perform phase difference detection of the chirp signals between two modules one by one, and to obtain the phase difference of the chirp signals in a combination of all the modules. However, according to the configuration of the specific example, even if the baseband signal is generated by mixing the chirp signals transmitted by the plurality of modules, it is possible to identify the module of the signal source of the chirp signal on which the baseband signal is based. As a result, the phase relationship of each chirp signal among the plurality of modules can be simultaneously detected, and the detection time can be greatly shortened.

Note that, in the specific example, in order to multiplex the chirp signals of the modules, the configuration has been described in which the chirp signal sources start generating and outputting the chirp signals at different timings. However, the chirp signal control unit 7 may perform control so that the chirp signal sources generate chirp signals having frequencies different from each other. This also provides a similar effect.

Hereinafter, a modification of the mixer included in each module of the radar device 200 according to the first embodiment will be described. In the modification, the mixer included in each module of the radar device 200 is an image rejection mixer (IRM).

FIG. 5A is a graph illustrating a chirp waveform generated by each chirp signal source of the four modules according to the modification. FIG. 5B is an enlarged view of the graph (dotted line portion) of FIG. 5A. In FIGS. 5A and 5B, the vertical axis represents the frequency of each chirp signal, and the horizontal axis represents time.

Also in the modification, in order to enable the reception side to separate the four chirp signals output from the four chirp signal sources, the chirp signal control unit 7 performs control so that the four chirp signal sources start generating and outputting chirp signals at timings different from each other.

The chirp signal control unit 7 performs control so that the chirp signal source 2-1 of the first module 101-1 starts generating and outputting the chirp signal earliest among the chirp signal sources of the first module 101-1, the second module 101-2, the third module (not illustrated), and the fourth module (not illustrated). Next, after a delay of a time T_{d} after the chirp signal source 2-1 of the first module 101-1 starts generating the chirp signal, the chirp signal control unit 7 performs control so that the chirp signal source 2-2 of the second module 101-2 starts generating and outputting the chirp signal. Next, after a delay of a time T_{d} after the chirp signal source 2-2 of the second module 101-2 starts generating the chirp signal, the chirp signal control unit 7 performs control so that the chirp signal source of the third module starts generating and outputting the chirp signal. Next, after a delay of a time T_{d} after the chirp signal source of the third module starts generating the chirp signal, the chirp signal control unit 7 performs control so that the chirp signal source of the fourth module starts generating and outputting the chirp signal.

That is, after the chirp signal source 2-1 of the first module 101-1 first outputs the chirp signal, the output of the chirp signal is started in the order of the chirp signal source 2-2 of the second module 101-2, the chirp signal source of the third module, and the chirp signal source of the fourth module at intervals of a time T_{d}. In this case, the frequency differences between the chirp signals temporally adjacent to each other are all f_{d}. That is, the frequency difference between the frequency of the chirp signal output from the chirp signal source 2-1 of first module 101-1 and the frequency of the chirp signal output from the chirp signal source 2-2 of the second module 101-2 is f_{d}. The frequency difference between the frequency of the chirp signal output from the chirp signal source 2-2 of the second module 101-2 and the frequency of the chirp signal output from the chirp signal source of the third module is f_{d}. The frequency difference between the frequency of the chirp signal output from the chirp signal source of the third module and the frequency of the chirp signal output from the chirp signal source of the fourth module is f_{d}.

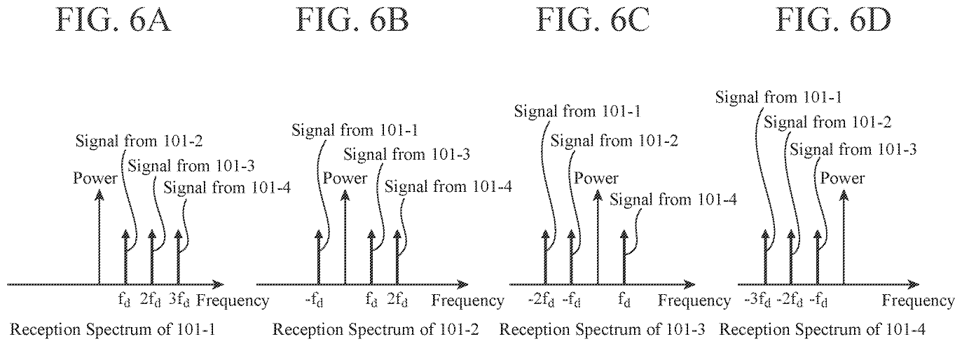

FIGS. 6A, 6B, 6C, and 6D are graphs each illustrating a spectrum of a beat signal (baseband signal) in the modification. In FIGS. 6A, 6B, 6C, and 6D, the vertical axis represents the power of the beat signal, and the horizontal axis represents the frequency of the beat signal.

More specifically, FIG. 6A is a graph showing a spectrum of a beat signal generated by an image rejection mixer which is the mixer 5-1 of the first module 101-1. FIG. 6B is a graph showing a spectrum of a beat signal generated by an image rejection mixer which is the mixer 5-2 of the second module 101-2. FIG. 6C is a graph showing a spectrum of a beat signal generated by an image rejection mixer that is a mixer of the third module. FIG. 6D is a graph showing a spectrum of a beat signal generated by an image rejection mixer that is a mixer of the fourth module.

For example, the spectrum of the frequency f_{d} illustrated in FIG. 6B indicates the frequency of a mixed wave of the chirp signal generated by the chirp signal source 2-2 of the second module 101-2 and the chirp signal received by the reception antenna 4-2 of the second module 101-2 from the transmission antenna of the third module. Note that, here, for simplification, the propagation delay time of the radio wave between the second module 101-2 and the third module is ignored.

In addition, the spectrum of the frequency −f_{d} illustrated in FIG. 6B indicates the frequency of the mixed wave of the chirp signal generated by the chirp signal source 2-2 of the second module 101-2 and the chirp signal received by the reception antenna 4-2 of the second module 101-2 from the transmission antenna 3-1 of the first module 101-1. Note that, here, for simplification, the propagation delay time of the radio wave between the first module 101-1 and the second module 101-2 is ignored.

As described above, since the mixer included in each module of the radar device 200 is the image rejection mixer, it is possible to distinguish positive or negative signs of the frequencies of each mixed waves. Therefore, even if the start timings of generation and output of the chirp signal by each chirp signal sources are shifted at equal intervals, mixed waves derived from different modules do not have frequencies overlapping, and separation can be easily performed.

Note that, in the configuration of the modification, the maximum value of the frequency of the mixed wave appearing in the beat signal is smaller than that in the configuration described in the above-described specific example (4 f_{d}→3 f_{d}). That is, there is an advantage that the frequency band of the signal to be converted by the analog-to-digital converter may be narrow.

As described above, the radar device 200 according to the first embodiment is the radar device 200 including a plurality of modules, each of the plurality of modules including a chirp signal source, a transmission antenna, a reception antenna, a mixer, and an analog-to-digital converter, in which the chirp signal source generates a chirp signal, the transmission antenna transmits the chirp signal generated by the chirp signal source, the reception antenna directly receives chirp signals transmitted by transmission antennas of modules other than a module to which the reception antenna belongs among the plurality of modules, the mixer generates a baseband signal by mixing the chirp signal generated by the chirp signal source and the chirp signals received by the reception antenna, and the analog-to-digital converter generates a digital signal by digital-converting the baseband signal generated by the mixer.

According to the above configuration, the chirp signal transmitted by the transmission antenna of one module is directly received by the reception antenna of the other module. As a result, it is possible to detect a phase difference of signals between antennas without preparing a reflector. Therefore, even during operation of the radar device, it is possible to detect the phase difference of the signals between the antennas. Even when the phase difference fluctuates, the correction can be performed.

In the above configuration, for example, when the reception antenna receives the chirp signals from the plurality of modules, it is necessary to separate the chirp signals arriving from the plurality of modules. Therefore, the radar device 200 according to the first embodiment further includes a chirp signal control unit to perform control so that the chirp signal sources of the plurality of modules generate chirp signals each having at least one of a chirp start timing and a frequency different from each other.

According to the above configuration, even if the beat signal that is the baseband signal is generated by mixing the chirp signals transmitted by the plurality of modules, the frequencies of the beat signals derived from the chirp signals do not overlap. Therefore, it is possible to identify the module of the signal source of the chirp signal on which the beat signal is based. As a result, the phase relationship of each chirp signal among the plurality of modules can be simultaneously detected, and the detection time can be greatly shortened.

Each mixer of the plurality of modules included in the radar device 200 according to the first embodiment is an image rejection mixer.

According to the above configuration, it is possible to distinguish positive or negative signs of the frequencies of each mixed waves in the frequency spectrum of the baseband signal. Therefore, even if the start timings of generating and outputting the chirp signal are shifted at equal intervals, the mixed waves derived from different modules do not have frequencies overlapping with each other, and separation can be easily performed.

The radar device 200 according to the first embodiment further includes the phase difference detection unit 8 to detect the phase difference of the chirp signal between the modules on the basis of the digital signal generated by the analog-to-digital converter.

According to the above configuration, the phase difference detection unit can suitably detect the phase difference of the signal between the modules. That is, the phase difference of the chirp signal between the antennas can be suitably detected.

In addition, the phase difference detection unit 8 included in the radar device 200 according to the first embodiment detects the frequency difference of the chirp signal between the modules generated by the control by the chirp signal control unit 7 on the basis of the digital signal generated by the analog-to-digital converter, thereby identifying the module of the signal source of the chirp signal on which the digital signal is based.

According to the above configuration, even if the baseband signal is generated by mixing the chirp signals transmitted by the plurality of modules, it is possible to identify the module of the signal source of the chirp signal on which the baseband signal is based.

### Second Embodiment

In the first embodiment, the configuration in which in each module, the transmission chirp signal transmitted by the transmission antenna and the mixing chirp signal to be mixed with the chirp signals received by the reception antenna by the mixer are the same has been described. In a second embodiment, a configuration in which a transmission chirp signal and a mixing chirp signal are separately generated in each module will be described.

The second embodiment will be described below by referring to the drawings. Note that, the same reference numerals are given to the components having the same functions as those described in the first embodiment, and the description thereof will be omitted.

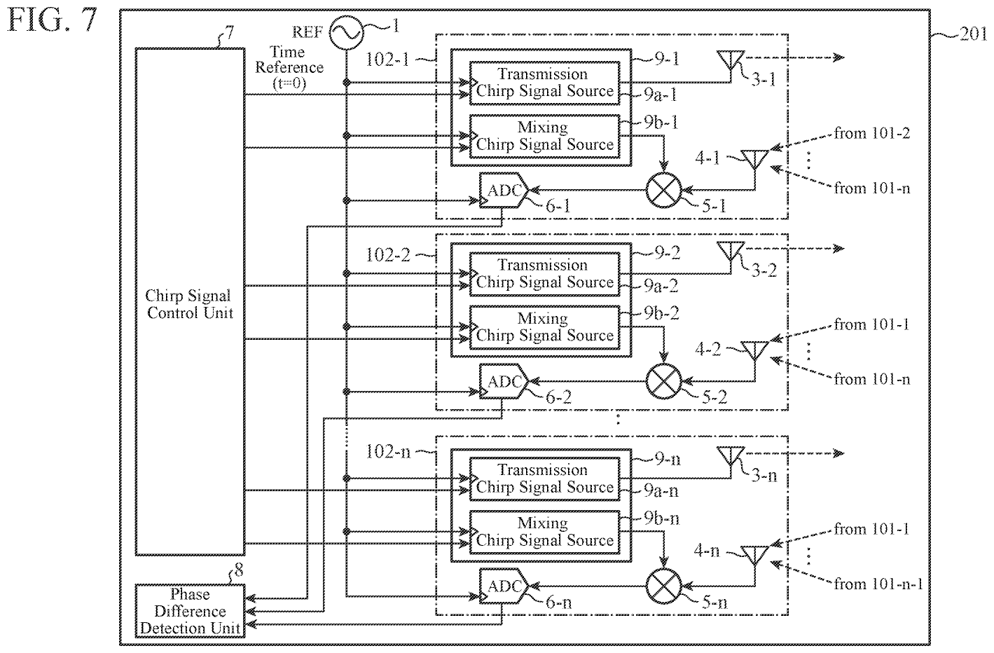

FIG. 7 is a block diagram showing a configuration of a radar device 201 according to the second embodiment. As illustrated in FIG. 7, the radar device 201 includes n modules including a first module 102-1 and a second module 102-2 instead of the n modules including the first module 101-1 and the second module 101-2 as compared with the radar device 200 according to the first embodiment.

More specifically, each chirp signal source of the n modules in the radar device 201 includes a transmission chirp signal source and a mixing chirp signal source. Since each of the chirp signal sources of the n modules according to the second embodiment has the same configuration, a chirp signal source 9-1 of the first module 102-1 will be described below as a representative. The chirp signal source 9-1 includes a transmission chirp signal source 9a-1 and a mixing chirp signal source 9b-1. Note that the chirp signal source 9-2 of the second module 102-2 includes a transmission chirp signal source 9a-2 and a mixing chirp signal source 9b-2.

The transmission chirp signal source 9a-1 of the first module 102-1 generates a transmission chirp signal. More specifically, the transmission chirp signal source 9a-1 generates the transmission chirp signal in synchronization with the reference signal. More specifically, the transmission chirp signal source 9a-1 generates the transmission chirp signal under the control of the chirp signal control unit 7. The transmission chirp signal source 9a-1 outputs the generated transmission chirp signal to the transmission antenna 3-1.

The mixing chirp signal source 9b-1 of the chirp signal source 9-1 of the first module 102-1 generates a mixing chirp signal. More specifically, the mixing chirp signal source 9b-1 generates the mixing chirp signal in synchronization with the reference signal. More specifically, the mixing chirp signal source 9b-1 generates the mixing chirp signal under the control of the chirp signal control unit 7. The mixing chirp signal source 9b-1 outputs the generated mixing chirp signal to the mixer 5-1.

The transmission antenna 3-1 of the first module 102-1 transmits the transmission chirp signal generated by the transmission chirp signal source 9a-1.

The reception antenna 4-1 of the first module 102-1 directly receives transmission chirp signals transmitted by the transmission antennas of modules other than the module to which it belongs among the n modules. Here, the “module to which it belongs” is the first module 102-1, and the reception antenna 4-1 directly receives the chirp signals transmitted by the transmission antennas of at least one or more modules other than the first module 102-1. The reception antenna 4-1 outputs the received chirp signals to the mixer 5-1.

The mixer 5-1 of the first module 102-1 generates a baseband signal by mixing the mixing chirp signal generated by the mixing chirp signal source 9b-1 and the transmission chirp signals received by the reception antenna 4-1.

As in the first embodiment, the analog-to-digital converter 6-1 of the first module 102-1 generates a digital signal by digital-converting the baseband signal generated by the mixer 5-1.

The chirp signal control unit 7 of the first module 102-1 controls each transmission chirp signal source and each mixing chirp signal source of the n modules. More specifically, the chirp signal control unit 7 of the first module 102-1 performs control so that the transmission chirp signal sources of the n modules generate chirp signals each having at least one of a chirp start timing and a frequency different from each other. Further, in the second embodiment, the chirp signal control unit 7 of the first module 102-1 performs control so that the transmission chirp signal sources of the n modules and the mixing chirp signal source of the first module 102-1 generate chirp signals each having at least one of a chirp start timing and a frequency different from each other.

As in the first embodiment, the phase difference detection unit 8 of the first module 102-1 detects the phase difference of the chirp signal between the modules on the basis of the digital signal generated by the analog-to-digital converter 6-1. Here, the phase difference of the chirp signal between the modules is a phase difference between the transmission chirp signal and the mixing chirp signal. In addition, the phase difference detection unit 8 detects the frequency difference of the chirp signal between the modules generated by the control by the chirp signal control unit 7 on the basis of the digital signal generated by the analog-to-digital converter 6-1, thereby identifying the module of the signal source of the transmission chirp signal on which the digital signal is based. Here, the frequency difference of the chirp signal between the modules is a frequency difference between the transmission chirp signal and the mixing chirp signal.

Next, the operation of the radar device 201 according to the second embodiment will be described. Hereinafter, as a representative, a configuration for detecting a phase difference between the chirp signal of the first module 102-1 and the chirp signal of the second module 102-2 is assumed. The operation described below can be generalized by setting “first” to i and setting “second” to h (i and h are positive integers).

First, the transmission chirp signal source 9a-1 of the first module 102-1 generates a transmission chirp signal in synchronization with the reference signal. The transmission chirp signal source 9a-1 outputs the generated transmission chirp signal to the transmission antenna 3-1. The transmission antenna 3-1 of the first module 102-1 transmits the transmission chirp signal generated by the transmission chirp signal source 9a-1 to the second module 102-2 as a radio wave.

On the other hand, the mixing chirp signal source 9b-2 of the second module 102-2 generates a mixing chirp signal in synchronization with the reference signal, and outputs the generated mixing chirp signal to the mixer 5-2. The reception antenna 4-2 of the second module 102-2 directly receives the transmission chirp signal transmitted by the transmission antenna 3-1 of the first module 102-1.

Next, the mixer 5-2 of the second module 102-2 generates a baseband signal by mixing the chirp signal generated by the mixing chirp signal source 9b-2 and the transmission chirp signal received by the reception antenna 4-2.

Next, the analog-to-digital converter 6-2 of the second module 102-2 generates a digital signal by digital-converting the baseband signal generated by the mixer 5-2. The analog-to-digital converter 6-2 outputs the generated digital signal to the phase difference detection unit 8.

Next, the phase difference detection unit 8 detects the phase difference of the chirp signal between the first module 102-1 and the second module 102-2 on the basis of the digital signal generated by the analog-to-digital converter 6-2.

More specifically, regarding the phase difference of the chirp signal between the first module 102-1 and the second module 102-2, for example, when the phase of the transmission chirp signal generated by the transmission chirp signal source 9a-1 of the first module 102-1 and transmitted by the transmission antenna 3-1 is φₛₐ(1), the phase of the transmission chirp signal received by the reception antenna 4-2 of the second module 102-2 is φₛₐ(1)+φ_{d}(2, 1). φ_{d}(2, 1) is a phase delay amount of propagation from the transmission antenna 3-1 of the first module 102-1 to the reception antenna 4-2 of the second module 102-2. Note that, here, the phase delay amount of the transmission chirp signal due to the path from the transmission chirp signal source 9a-1 to the transmission antenna 3-1 in the first module 102-1 is ignored.

When the phase of the mixing chirp signal generated by the mixing chirp signal source 9b-2 of the second module 102-2 is φ_{sb}(2), the phase difference between the phase of the mixing chirp signal generated by the mixing chirp signal source 9b-2 and the phase of the transmission chirp signal received by the reception antenna 4-2 in the mixer 5-2 of the second module 102-2 is φₛₐ(1)+φ_{d}(2, 1)−φ_{sb}(2). Here, the phase delay amount of the chirp signal between the circuits in the second module 102-2 is also ignored.

That is, assuming that φ_{d}(2, 1) is unchanged, the radar device 201 can detect the phase difference φₛₐ(1)−φ_{sb}(2) between the phase of the transmission chirp signal generated by the transmission chirp signal source 9a-1 of the first module 102-1 and the phase of the mixing chirp signal generated by the mixing chirp signal source 9b-2 of the second module 102-2 by the phase difference detection unit 8 by observing the phase difference.

Note that, in the second embodiment, the configuration has been described in which the radar device 201 includes, in each module, two chirp signal sources (the transmission chirp signal source and the mixing chirp signal source), each generating the chirp signals in synchronization with the reference clock. However, it is not necessary to prepare two chirp signal sources, and the radar device 201 may generate the transmission chirp signal or the mixing chirp signal, for example, by each module including only one chirp signal source and further including a configuration in which a time delay or a frequency offset is provided for the chirp signal output from the chirp signal source. Also with such a configuration, a similar effect can be obtained.

Hereinafter, a specific example of control by the chirp signal control unit 7 according to the second embodiment will be described in more detail with reference to the drawings.

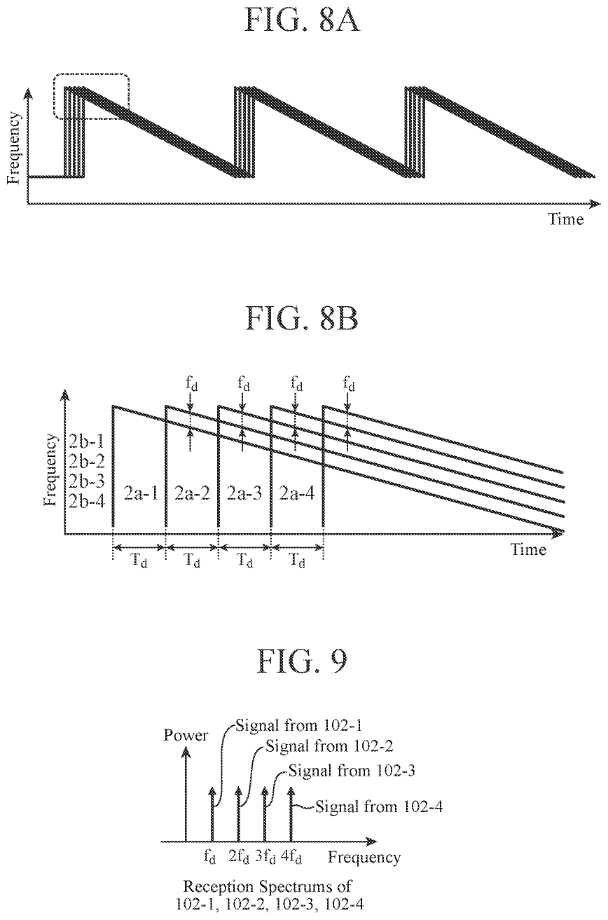

FIG. 8A is a graph illustrating a chirp waveform generated by each chirp signal source of the four modules. FIG. 8B is an enlarged view of the graph (dotted line portion) of FIG. 8A. In the following description, it is assumed that the number of modules included in the radar device 201 is four (n=4). In FIGS. 8A and 8B, the vertical axis represents the frequency of each chirp signal, and the horizontal axis represents time.

In this specific example, in order to enable the reception side to separate the four chirp signals output from the four chirp signal sources, the chirp signal control unit 7 performs control so that the four chirp signal sources start generating and outputting chirp signals at different timings.

First, the chirp signal control unit 7 performs control so that the mixing chirp signal source 9b-1 of the first module 102-1, the mixing chirp signal source 9b-2 of the second module 102-2, the mixing chirp signal source (not illustrated) of the third module, and the mixing chirp signal source (not illustrated) of the fourth module start generating and outputting the mixing chirp signals at the same time.

Next, after a delay of a time T_{d} after the mixing chirp signal source of each module starts generating the mixing chirp signal, the chirp signal control unit 7 performs control so that the transmission chirp signal source 9a-1 of the first module 102-1 starts generating and outputting the transmission chirp signal earliest among the transmission chirp signal sources of the first module 102-1, the second module 102-2, the third module, and the fourth module.

Next, after a delay of a time T_{d} after the transmission chirp signal source 9a-1 of the first module 102-1 starts generating the transmission chirp signal, the chirp signal control unit 7 performs control so that the transmission chirp signal source 9a-2 of the second module 102-2 starts generating and outputting the transmission chirp signal having the same parameter as the parameter of the transmission chirp signal generated by the transmission chirp signal source 9a-1 of the first module 102-1.

Next, after a delay of a time T_{d} after the transmission chirp signal source 9a-2 of the second module 102-2 starts generating the transmission chirp signal, the chirp signal control unit 7 performs control so that the transmission chirp signal source of the third module starts generating and outputting the transmission chirp signal. Next, after a delay of a time T_{d} after the transmission chirp signal source of the third module starts generating the transmission chirp signal, the chirp signal control unit 7 performs control so that the transmission chirp signal source of the fourth module starts generating and outputting the transmission chirp signal.

As a result, as illustrated in FIGS. 8A and 8B, the start timing of each chirp signal is shifted.

The starting frequencies of the chirp signals output from each transmission chirp signal sources and each mixing chirp signal sources are the same, and the frequency change rates (α) of the chirp signals output from each transmission chirp signal sources and each mixing chirp signal sources are the same. Therefore, when the output start time of the chirp signal is shifted by T_{d}, the frequency is shifted by f_{d}=α×T_{d}. More specifically, the frequency difference between the frequency of the mixing chirp signal output from the mixing chirp signal source of each module and the frequency of the transmission chirp signal output from the transmission chirp signal source 9a-1 of the first module 102-1 is f_{d}. The frequency difference between the frequency of the transmission chirp signal output from the transmission chirp signal source 9a-1 of the first module 102-1 and the frequency of the transmission chirp signal output from the transmission chirp signal source 9a-2 of the second module 102-2 is f_{d}. The frequency difference between the frequency of the transmission chirp signal output from the transmission chirp signal source 9a-2 of the second module 102-2 and the frequency of the transmission chirp signal output from the transmission chirp signal source of the third module is f_{d}. The frequency difference between the frequency of the transmission chirp signal output from the transmission chirp signal source of the third module and the frequency of the transmission chirp signal output from the transmission chirp signal source of the fourth module is f_{d}.

FIG. 9 is a graph illustrating a frequency spectrum of a beat signal (baseband signal) generated by the mixer of each module in the specific example. That is, the frequency spectrum of the beat signal generated by the mixer of each module indicates the same spectrum. In FIG. 9, the vertical axis represents the power of the beat signal, and the horizontal axis represents the frequency of the beat signal. Note that the beat signal generated by the mixer 5-1 of the first module 102-1 will be described below as a representative.

In the first module 102-1, the reception antenna 4-1 receives the transmission chirp signals output from the transmission antenna 3-1, the second module 102-2, the third module, and the fourth module. Next, in the first module 102-1, the mixer 5-1 generates a beat signal which is a baseband signal by mixing the mixing chirp signal generated by the mixing chirp signal source 9b-1 and each transmission chirp signal received by the reception antenna 4-1.

For example, the spectrum having the frequency f_{d} illustrated in FIG. 9 indicates the frequency of a mixed wave of the mixing chirp signal generated by the mixing chirp signal source 9b-1 of the first module 102-1 and the transmission chirp signal received by the reception antenna 4-1 of the first module 102-1 from the transmission antenna 3-1 of the first module 102-1. Note that, here, for simplification, the propagation delay time of the radio wave between the transmission antenna 3-1 and the reception antenna 4-1 is ignored.

The spectrum having the frequency 2 f_{d} illustrated in FIG. 9 indicates the frequency of a mixed wave of the mixing chirp signal generated by the mixing chirp signal source 9b-1 of the first module 102-1 and the transmission chirp signal received by the reception antenna 4-1 of the first module 102-1 from the transmission antenna 3-2 of the second module 102-2. Note that, here, for simplification, the propagation delay time of the radio wave between the first module 102-1 and the second module 102-2 is ignored.

The spectrum having the frequency 3 f_{d} illustrated in FIG. 9 indicates the frequency of the mixed wave of the mixing chirp signal generated by the mixing chirp signal source 9b-1 of the first module 102-1 and the transmission chirp signal received by the reception antenna 4-1 of the first module 102-1 from the transmission antenna of the third module. Note that, here, for simplification, the propagation delay time of the radio wave between the first module 102-1 and the third module is ignored.

The spectrum having the frequency 4 f_{d} illustrated in FIG. 9 indicates the frequency of a mixed wave of the mixing chirp signal generated by the mixing chirp signal source 9b-1 of the first module 102-1 and the transmission chirp signal received by the reception antenna 4-1 of the first module 102-1 from the transmission antenna of the fourth module. Note that, here, for simplification, the propagation delay time of the radio wave between the first module 102-1 and the fourth module is ignored.

As described above, since all the mixed waves derived from the transmission chirp signals received from the four modules have different frequencies, the mixed waves can be easily separated by spectrum analysis, and the phases of the transmission chirp signals can be calculated.

The spectrum of the beat signal generated by the mixer 5-2 of the second module 102-2, the spectrum of the beat signal generated by the mixer of the third module, and the spectrum of the beat signal generated by the mixer of the fourth module are similar to the spectrum of the beat signal generated by the mixer 5-1 of the first module 102-1. As illustrated in FIG. 9, also in the second module 102-2, the third module, or the fourth module, the frequency of each mixed wave is shifted for each derived module, and can be easily separated.

Then, on the basis of the digital signal generated by the analog-to-digital converter 6-1, the phase difference detection unit 8 can detect the frequency difference of the chirp signal between the modules, which is caused by the control by the chirp signal control unit 7, and identify the module of the signal source of the transmission chirp signal on which the digital signal is based from the frequency difference.

Note that, in the specific example, the configuration has been described in which, in order to multiplex the chirp signals (the transmission chirp signal and the mixing chirp signal) of the modules, the chirp signal sources start generating and outputting the chirp signals at timings different from each other. However, the chirp signal control unit 7 may perform control so that the chirp signal sources generate chirp signals having frequencies different from each other. This also provides a similar effect.

Hereinafter, a modification of the mixer included in each module of the radar device 201 according to the second embodiment will be described. In the modification, the mixer included in each module of the radar device 201 is an image rejection mixer (IRM).

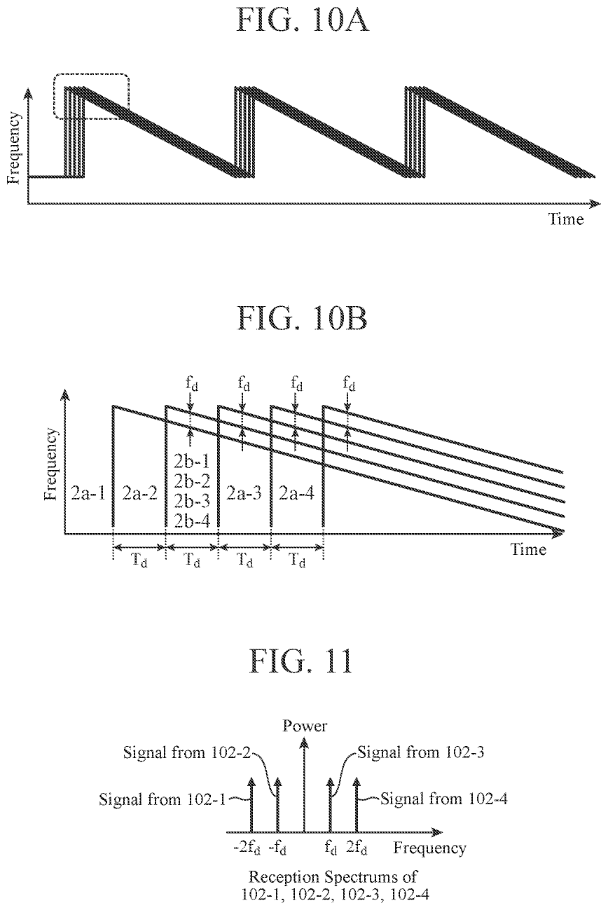

FIG. 10A is a graph illustrating a chirp waveform generated by each chirp signal source of four modules according to the modification. FIG. 10B is an enlarged view of the graph (dotted line portion) in FIG. 10A. In FIGS. 10A and 10B, the vertical axis represents the frequency of each chirp signal, and the horizontal axis represents time.

Also in the modification, in order to enable the reception side to separate the four chirp signals output from the four chirp signal sources, the chirp signal control unit 7 performs control so that the four chirp signal sources start generating and outputting chirp signals at timings different from each other.

The chirp signal control unit 7 performs control so that the transmission chirp signal source 9a-1 of the first module 102-1 starts generating and outputting the transmission chirp signal earliest among the transmission chirp signal sources of the first module 102-1, the second module 102-2, the third module (not illustrated), and the fourth module (not illustrated). Next, after a delay of a time T_{d} after the transmission chirp signal source 9a-1 of the first module 102-1 starts generating the transmission chirp signal, the chirp signal control unit 7 performs control so that the transmission chirp signal source 9a-2 of the second module 102-2 starts generating and outputting the transmission chirp signal.

Next, after a delay of a time T_{d} after the transmission chirp signal source 9a-2 of the second module 102-2 starts generating the transmission chirp signal, the chirp signal control unit 7 performs control so that the mixing chirp signal source 9b-1 of the first module 102-1, the mixing chirp signal source 9b-2 of the second module 102-2, the mixing chirp signal source (not illustrated) of the third module, and the mixing chirp signal source (not illustrated) of the fourth module start generating and outputting the mixing chirp signal at the same time.

Next, after a delay of a time T_{d} after each mixing chirp signal source starts generating the mixing chirp signal, the chirp signal control unit 7 performs control so that the transmission chirp signal source of the third module starts generating and outputting the transmission chirp signal. Next, after a delay of a time T_{d} after the transmission chirp signal source of the third module starts generating the transmission chirp signal, the chirp signal control unit 7 performs control so that the transmission chirp signal source of the fourth module starts generating and outputting the transmission chirp signal.

That is, after the transmission chirp signal source 9a-1 of the first module 102-1 first outputs the transmission chirp signal, the output of the chirp signal is started in the order of the transmission chirp signal source 9a-2 of the second module 102-2, the mixing chirp signal source of each module, the transmission chirp signal source of the third module, and the transmission chirp signal source of the fourth module at the time interval T_{d}. In this case, the frequency differences between the chirp signals temporally adjacent to each other are all f_{d}. That is, the frequency difference between the frequency of the transmission chirp signal output from the transmission chirp signal source 9a-1 of the first module 102-1 and the frequency of the transmission chirp signal output from the transmission chirp signal source 9a-2 of the second module 102-2 is f_{d}. The frequency difference between the frequency of the transmission chirp signal output from the transmission chirp signal source 9a-2 of the second module 102-2 and the frequency of the mixing chirp signal output from the mixing chirp signal source of each module is f_{d}. The frequency difference between the frequency of the mixing chirp signal output from the mixing chirp signal source of each module and the frequency of the transmission chirp signal output from the transmission chirp signal source of the third module is f_{d}. The frequency difference between the frequency of the transmission chirp signal output from the transmission chirp signal source of the third module and the frequency of the transmission chirp signal output from the transmission chirp signal source of the fourth module is f_{d}.

FIG. 11 is a graph illustrating a frequency spectrum of a beat signal (baseband signal) generated by the mixer of each module in the modification. That is, the frequency spectrum of the beat signal generated by the mixer of each module indicates the same spectrum. In FIG. 11, the vertical axis represents the power of the beat signal, and the horizontal axis represents the frequency of the beat signal. Note that the beat signal generated by the mixer 5-1 of the first module 102-1 will be described below as a representative.

For example, the spectrum having the frequency f_{d} illustrated in FIG. 11 indicates the frequency of the mixed wave of the mixing chirp signal generated by the mixing chirp signal source 9b-1 of the first module 102-1 and the transmission chirp signal received by the reception antenna 4-1 of the first module 102-1 from the transmission antenna of the third module. Note that, here, for simplification, the propagation delay time of the radio wave between the first module 102-1 and the third module is ignored.

In addition, the spectrum of the frequency −f_{d} illustrated in FIG. 11 indicates the frequency of a mixed wave of the mixing chirp signal generated by the mixing chirp signal source 9b-1 of the first module 102-1 and the chirp signal received by the reception antenna 4-1 of the first module 102-1 from the transmission antenna 3-2 of the second module 102-2. Note that, here, for simplification, the propagation delay time of the radio wave between the first module 102-1 and the second module 102-2 is ignored.

As described above, since the mixer included in each module of the radar device 201 is the image rejection mixer, it is possible to distinguish positive or negative signs of the frequencies of each mixed waves. Then, it is possible to separate the mixed wave based on the transmission chirp signal whose start timing is later than the mixing chirp signal and the mixed wave based on the transmission chirp signal whose start timing is earlier than the mixing chirp signal.

Note that, in the configuration of the modification, the maximum value of the frequency of the mixed wave appearing in the beat signal is smaller than that in the configuration described in the above-described specific example (4 f_{d}→2 f_{d}). That is, there is an advantage that the frequency band of the signal to be converted by the analog-to-digital converter may be narrow.

Hereinafter, a modification of the module included in the radar device 201 according to the second embodiment will be described. In this modification, the n modules include a target transmission module.

The transmission antenna of the target transmission module transmits the transmission chirp signal generated by the transmission chirp signal source of the target transmission module to the target. Examples of a method in which the transmission antenna of the target transmission module transmits the transmission chirp signal to the target include a method of increasing transmission wave power and a method of directing the transmission direction of the transmission chirp signal toward the target direction.

In the modification, the chirp signal control unit 7 performs control so that the transmission chirp signal sources of the n modules generate chirp signals having different start timings, and the transmission chirp signal source of the target transmission module generates a chirp signal having the latest start timing among the transmission chirp signal sources of the n modules. Furthermore, in the modification, the phase difference detection unit 8 further detects the frequency of the chirp signal derived from the distance to the target, the speed of the target, or the like. The phase difference detection unit 8 may calculate the distance to the target, the speed of the target, or the like on the basis of the frequency.

Hereinafter, the fourth module (not illustrated) is used as a target transmission module. That is, the transmission antenna of the fourth module transmits the chirp signal generated by the chirp signal source of the fourth module to the target. The chirp signal control unit 7 performs control so that the transmission chirp signal sources of the four modules generate chirp signals having different start timings, and the fourth transmission chirp signal source generates a chirp signal having the latest start timing among the transmission chirp signal sources of the four modules.

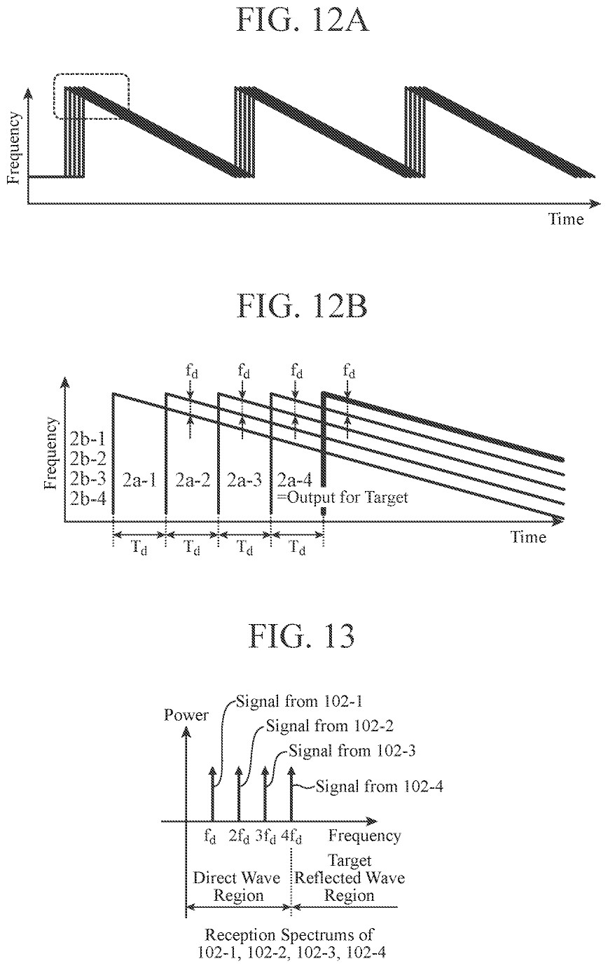

FIG. 12A is a graph illustrating a chirp waveform generated by each chirp signal source of the four modules according to the modification. FIG. 12B is an enlarged view of the graph (dotted line portion) in FIG. 12A. In FIGS. 12A and 12B, the vertical axis represents the frequency of each chirp signal, and the horizontal axis represents time.

Also in the modification, in order to enable the reception side to separate the four chirp signals output from the four chirp signal sources, the chirp signal control unit 7 performs control so that the four chirp signal sources start generating and outputting chirp signals at timings different from each other.

The chirp signal control unit 7 performs control so that the transmission chirp signal source 9a-1 of the first module 102-1 starts generating and outputting the transmission chirp signal earliest among the transmission chirp signal sources of the first module 102-1, the second module 102-2, the third module (not illustrated), and the fourth module (not illustrated). Next, after a delay of a time T_{d} after the transmission chirp signal source 9a-1 of the first module 102-1 starts generating the transmission chirp signal, the chirp signal control unit 7 performs control so that the transmission chirp signal source 9a-2 of the second module 102-2 starts generating and outputting the transmission chirp signal.

Next, after a delay of a time T_{d} after the transmission chirp signal source 9a-2 of the second module 102-2 starts generating the transmission chirp signal, the chirp signal control unit 7 performs control so that the mixing chirp signal source 9b-1 of the first module 102-1, the mixing chirp signal source 9b-2 of the second module 102-2, the mixing chirp signal source (not illustrated) of the third module, and the mixing chirp signal source (not illustrated) of the fourth module start generating and outputting the mixing chirp signal at the same time.

Next, after a delay of a time T_{d} after each mixing chirp signal source starts generating the mixing chirp signal, the chirp signal control unit 7 performs control so that the transmission chirp signal source of the third module starts generating and outputting the transmission chirp signal. Next, after a delay of a time T_{d} after the transmission chirp signal source of the third module starts generating the transmission chirp signal, the chirp signal control unit 7 performs control so that the transmission chirp signal source of the fourth module, which is the target transmission module, starts generating and outputting the transmission chirp signal. That is, the chirp signal control unit 7 performs control so that the fourth transmission chirp signal source generates a chirp signal having the latest phase among the transmission chirp signal sources of the four modules.

FIG. 13 is a graph illustrating a frequency spectrum of a beat signal (baseband signal) generated by the mixer of each module in the modification. That is, the frequency spectrum of the beat signal generated by the mixer of each module indicates the same spectrum. In FIG. 13, the vertical axis represents the power of the beat signal, and the horizontal axis represents the frequency of the beat signal. Note that the beat signal generated by the mixer 5-1 of the first module 102-1 will be described below as a representative.

For example, the spectrum having the frequency f_{d} illustrated in FIG. 13 indicates the frequency of the mixed wave of the mixing chirp signal generated by the mixing chirp signal source 9b-1 of the first module 102-1 and the transmission chirp signal directly received by the reception antenna 4-1 of the first module 102-1 from the transmission antenna 3-1 of the first module 102-1. Similarly, the spectrum having the frequency 2 f_{d} illustrated in FIG. 13 indicates the frequency of the mixed wave of the mixing chirp signal generated by the mixing chirp signal source 9b-1 of the first module 102-1 and the transmission chirp signal directly received by the reception antenna 4-1 of the first module 102-1 from the transmission antenna 3-2 of the second module 102-2. The spectrum having the frequency 3 f_{d} illustrated in FIG. 13 indicates the frequency of the mixed wave of the mixing chirp signal generated by the mixing chirp signal source 9b-1 of the first module 102-1 and the transmission chirp signal directly received by the reception antenna 4-1 of the first module 102-1 from the transmission antenna of the third module. The spectrum having the frequency 4 f_{d} illustrated in FIG. 13 indicates the frequency of the mixed wave of the mixing chirp signal generated by the mixing chirp signal source 9b-1 of the first module 102-1 and the transmission chirp signal received by the reception antenna 4-1 of the first module 102-1 from the transmission antenna of the fourth module.

That is, in FIG. 13, the spectrum of the mixed wave derived from the chirp signal directly received from each module appears in the frequency region of 4 f_{d} or less. On the other hand, since the fourth transmission chirp signal source generates the chirp signal having the latest start timing among the transmission chirp signal sources of the four modules as described above, the spectrum of the mixed wave derived from the chirp signal transmitted by the fourth module and reflected from the target all appears in the frequency region higher than 4 f_{d} (not illustrated).

That is, the phase difference detection unit 8 can detect the phase difference of the chirp signal between the modules using the signal in the frequency region lower than 4 f_{d}, and at the same time, can detect the frequency of the chirp signal derived from the distance to the target, the speed of the target, or the like using the signal in the frequency region higher than 4 f_{d}. As a result, it is not necessary to provide a dedicated time period for detecting the phase difference of the chirp signal between the modules, and a limited time can be effectively used for the target measurement processing.

As described above, each of the chirp signal sources included in the plurality of modules of the radar device 201 according to the second embodiment includes a transmission chirp signal source to generate a transmission chirp signal and a mixing chirp signal source to generate a mixing chirp signal, the transmission antenna transmits the transmission chirp signal generated by the transmission chirp signal source, the reception antenna directly receives the transmission chirp signals transmitted by the transmission antennas of modules other than the module to which the reception antenna belongs among the plurality of modules, and the mixer generates a baseband signal by mixing the mixing chirp signal generated by the mixing chirp signal source and the transmission chirp signals received by the reception antenna.

According to the above configuration, the transmission chirp signal transmitted by the transmission chirp signal of one module is directly received by the reception antenna of the other module. As a result, it is possible to detect the phase difference of the chirp signal between the antennas without preparing a reflector.

In addition, the radar device 201 according to the second embodiment further includes the chirp signal control unit 7 to perform control so that the transmission chirp signal sources of the plurality of modules generate transmission chirp signals each having at least one of a chirp start timing and a frequency different from each other.

According to the above configuration, even when the baseband signal is generated by mixing the transmission chirp signals transmitted by the plurality of modules, it is possible to identify the module of the signal source of the transmission chirp signal on which the baseband signal is based. As a result, the phase relationship of each chirp signal among the plurality of modules can be simultaneously detected, and the detection time can be greatly shortened.

Furthermore, in the radar device 201 according to the second embodiment, the plurality of modules include a target transmission module, the transmission antenna of the target transmission module transmits the transmission chirp signal generated by the transmission chirp signal source of the target transmission module to the target, and the chirp signal control unit performs control so that the transmission chirp signal sources of the plurality of modules generate chirp signals having different start timings, and the transmission chirp signal source of the target transmission module generates a chirp signal having the latest start timing among the transmission chirp signal sources of the plurality of modules.

According to the above configuration, among the beat signals generated by the mixer, the frequency of the mixed wave derived from the chirp signal having the latest start timing generated by the transmission chirp signal source of the target transmission module is different from the frequencies of the mixed waves derived from the chirp signals generated by the modules other than the target transmission module. As a result, the chirp signal transmitted by the target transmission module can be identified. Therefore, the phase difference of the chirp signal between the modules can be detected, and at the same time, the frequency of the chirp signal derived from the distance to the target, the speed of the target, or the like can be detected. Therefore, it is not necessary to provide a dedicated time period for detecting the phase difference of the chirp signal between the modules, and a limited time can be effectively used for the target measurement processing.

### Third Embodiment

In the first embodiment, the configuration in which the chirp signal generated by the chirp signal source is directly output to the transmission antenna in each module has been described. In a third embodiment, a configuration in which a phase shifter is provided between a chirp signal source and a transmission antenna in each module will be described.

The third embodiment will be described below by referring to the drawings. Note that, the same reference numerals are given to the components having the same functions as those described in the first embodiment, and the description thereof will be omitted.

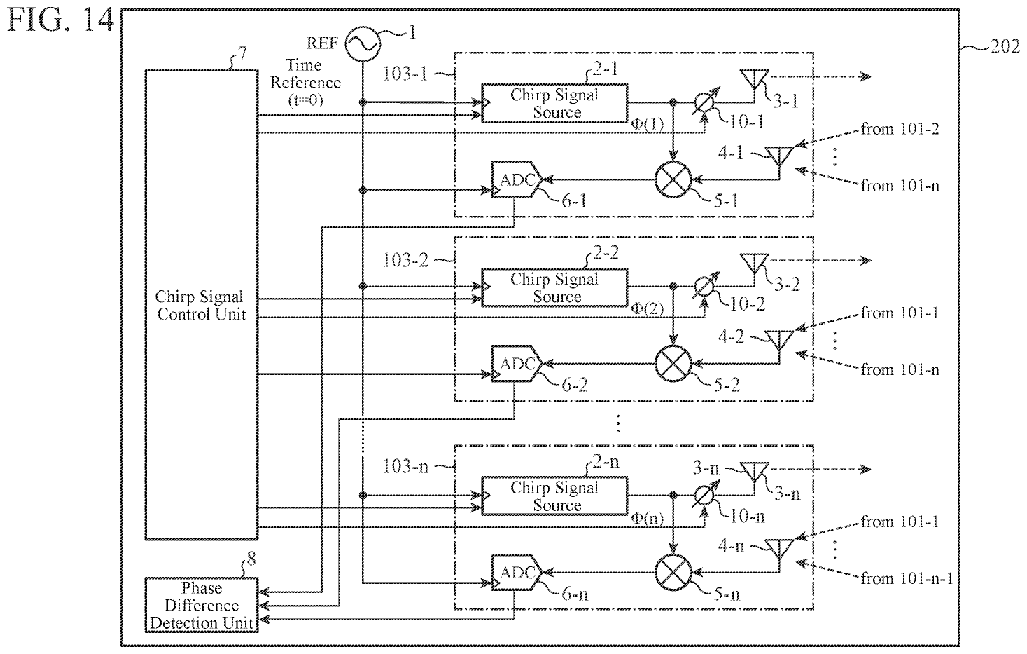

FIG. 14 is a block diagram showing a configuration of a radar device 202 according to the third embodiment. As illustrated in FIG. 14, the radar device 202 includes n modules including a first module 103-1 and a second module 103-2 instead of the n modules including the first module 101-1 and the second module 101-2 as compared with the radar device 200 according to the first embodiment. More specifically, each of the n modules in the radar device 202 further includes a phase shifter. Since each of the phase shifters of the n modules according to the third embodiment has the same configuration, a phase shifter 10-1 of the first module 103-1 will be described below as a representative. The second module 103-2 further includes a phase shifter 10-2.

The chirp signal source 2-1 of the first module 103-1 according to the third embodiment outputs the generated chirp signal to each of the phase shifter 10-1 and the mixer 5-1.

The phase shifter 10-1 performs phase modulation on the chirp signal generated by the chirp signal source. More specifically, in the third embodiment, the phase shifter 10-1 performs phase modulation on the chirp signal generated by the chirp signal source 2-1 under the control of the chirp signal control unit 7. Details will be described later. The phase shifter 10-1 outputs the phase-modulated chirp signal to the transmission antenna 3-1.

The transmission antenna 3-1 according to the third embodiment transmits a transmission chirp signal phase-modulated by the phase shifter 10-1.

The chirp signal control unit 7 according to the third embodiment further performs control so that the phase shifters of the n modules perform phase modulation using code sequences different from each other.

Hereinafter, a specific example of control by the chirp signal control unit 7 according to the third embodiment will be described in more detail with reference to the drawings.

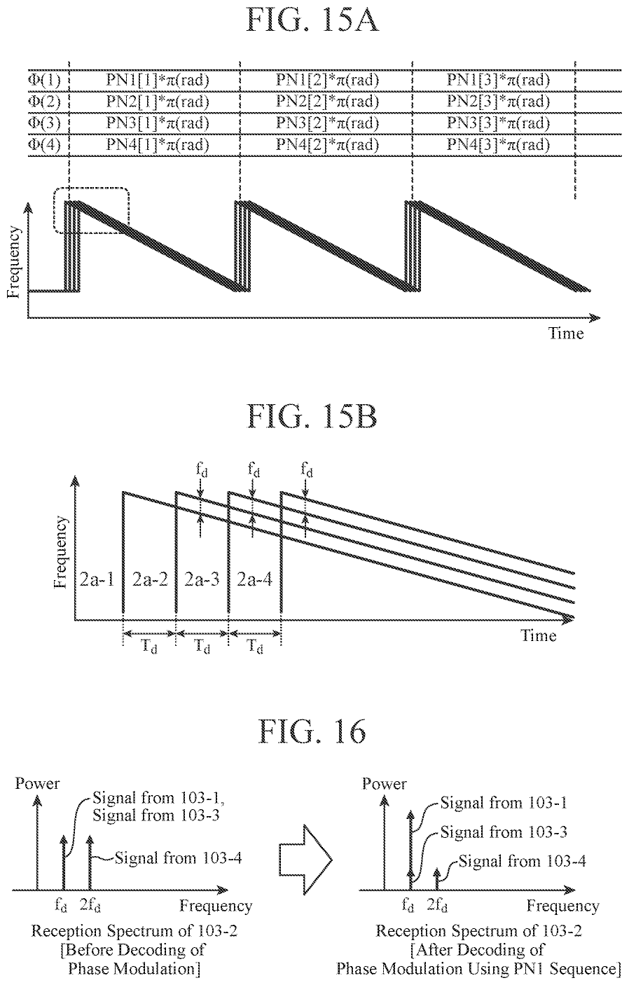

FIG. 15A is a graph illustrating a chirp waveform generated by each of the chirp signal sources of the four modules. FIG. 15B is an enlarged view of the graph (dotted line portion) in FIG. 15A. In the following description, it is assumed that the number of modules included in the radar device 202 is four (n=4). In FIGS. 15A and 15B, the vertical axis represents the frequency of each chirp signal, and the horizontal axis represents time.

Also in this specific example, in order to enable the reception side to separate the four chirp signals output from the four chirp signal sources, the chirp signal control unit 7 performs control so that the four chirp signal sources start generating and outputting chirp signals at different timings.

The chirp signal control unit 7 performs control so that the chirp signal source 2-1 of the first module 103-1 starts generating and outputting the chirp signal earliest among the chirp signal sources of the first module 103-1, the second module 103-2, the third module (not illustrated), and the fourth module (not illustrated). Next, after a delay of a time T_{d} after the chirp signal source 2-1 of the first module 103-1 starts generating the chirp signal, the chirp signal control unit 7 performs control so that the chirp signal source 2-2 of the second module 103-2 starts generating and outputting the chirp signal. Next, after a delay of a time T_{d} after the chirp signal source 2-2 of the second module 103-2 starts generating the chirp signal, the chirp signal control unit 7 performs control so that the chirp signal source of the third module starts generating and outputting the chirp signal. Next, after a delay of a time T_{d} after the chirp signal source of the third module starts generating the chirp signal, the chirp signal control unit 7 performs control so that the chirp signal source of the fourth module starts generating and outputting the chirp signal.

In this specific example, the chirp signal control unit 7 sets phase shift amounts of phase modulation performed by each of the phase shifter 10-1 of the first module 103-1, the phase shifter 10-2 of the second module 103-2, the phase shifter (not illustrated) of the third module, and the phase shifter (not illustrated) of the fourth module. Here, as illustrated in FIG. 15A, the phase shift amounts set by the chirp signal control unit 7 are set to Φ(1) to Φ(4). As illustrated in FIG. 15A, each phase shift amount has a different value for each hit (one sweep of the chirp). For example, the phase shift amount Φ(1) of the phase modulation in the phase shifter 10-1 of the first module 103-1 is PN1[1]*π(rad) for the first hit and PN1[2]*π(rad) for the second hit. Here, PN1[k] is a pseudo noise sequence such as an M sequence (k is a positive integer). That is, in the specific example, the chirp signal control unit 7 sets the phase shift amount of the phase modulation using different sequences for each module.

FIG. 16 is a graph illustrating a spectrum of a beat signal generated by the mixer 5-2 of the second module 103-2 according to the specific example. In FIG. 16, the graph on the left side is a graph illustrating the spectrum of the beat signal before decoding, and the graph on the right side is a graph illustrating the spectrum of the beat signal after decoding. In FIG. 16, the vertical axis of each graph represents the power of the beat signal, and the horizontal axis of each graph represents the frequency of the beat signal.

As illustrated in the graph on the left side of FIG. 16, the frequency of the mixed wave derived from the chirp signal transmitted from the transmission antenna 3-1 of the first module 103-1 and the frequency of the mixed wave derived from the chirp signal transmitted from the transmission antenna of the third module are f_{d} and overlap each other on the frequency axis.

Here, for example, when these beat signals are decoded using the PN1 sequence used in the phase modulation in the phase shifter 10-1 of the first module 103-1, the spectrum on the left side of FIG. 16 becomes the spectrum on the right side of FIG. 16. As indicated by the spectrum on the right side of FIG. 16, the power is combined and increased only for the mixed wave derived from the chirp signal from the first module 103-1. As a result, it is possible to reduce the influence of the mixed wave derived from the chirp signal from the third module having overlapping frequencies, and to separate only the mixed wave derived from the chirp signal from the first module 103-1. Similarly, when it is desired to extract the mixed wave derived from the chirp signal from another module, the mixed wave can be extracted by decoding the beat signal using the corresponding sequence. Furthermore, according to the specific example, it is possible to separate the chirp signals from the plurality of modules while suppressing the frequency band without using the image rejection mixer.

As described above, each of the plurality of modules in the radar device 202 according to the third embodiment further includes a phase shifter, the phase shifter performs phase modulation on the chirp signal generated by the chirp signal source, and the chirp signal control unit further performs control so that the phase shifters of the plurality of modules perform phase modulation using code sequences different from each other.

According to the above configuration, in the beat signal (baseband signal) generated by the mixer, even when the frequencies of the mixed waves derived from different modules overlap with each other, it is possible to separate the mixed waves by performing the signal processing corresponding to the phase modulation of each phase shifter on the beat signal. That is, it is possible to identify the module of the signal source of the chirp signal on which the beat signal is based.

### Fourth Embodiment

The functions of the chirp signal control unit 7 and the phase difference detection unit 8 in the radar device 200 according to the first embodiment, the radar device 201 according to the second embodiment, or the radar device 202 according to the third embodiment are implemented by a processing circuit. The processing circuit may be dedicated hardware or a central processing unit (CPU) that executes programs stored in a memory.

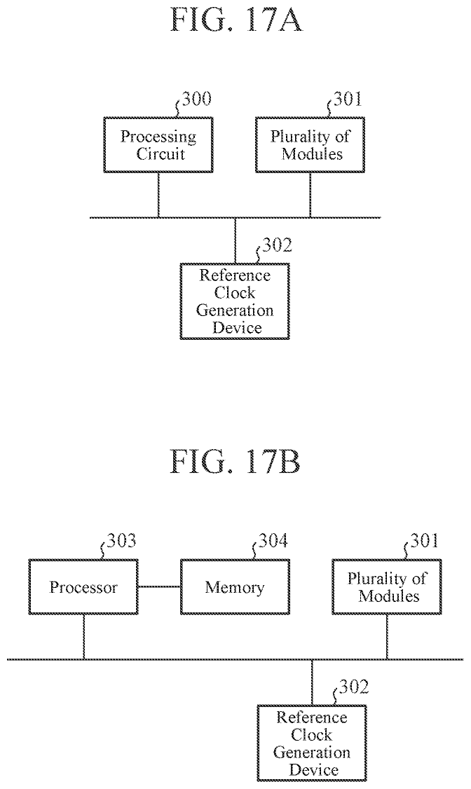

FIG. 17A is a block diagram illustrating a hardware configuration that implements the functions of the radar device 200, the radar device 201, or the radar device 202. FIG. 17B is a block diagram showing a hardware configuration for executing software that implements the functions of the radar device 200, the radar device 201, or the radar device 202. A plurality of modules 301 illustrated in FIGS. 17A and 17B execute the same functions as the n modules of each of the above-described embodiments. A reference clock generation device 302 illustrated in FIGS. 17A and 17B executes functions similar to those of the above-described REF1.

When the processing circuit is a processing circuit 300 of dedicated hardware shown in FIG. 17A, the processing circuit 300 corresponds, for example, to a single circuit, a composite circuit, a programmed processor, a parallel-programmed processor, an application specific integrated circuit (ASIC), a field-programmable gate array (FPGA), or a combination thereof.

The functions of the chirp signal control unit 7 and the phase difference detection unit 8 in the radar device 200, the radar device 201, or the radar device 202 may be implemented by separate processing circuits, or these functions may be collectively implemented by one processing circuit.

In a case where the processing circuit is a processor 303 illustrated in FIG. 17B, the functions of the chirp signal control unit 7 and the phase difference detection unit 8 in the radar device 200, the radar device 201, or the radar device 202 are implemented by software, firmware, or a combination of software and firmware.

Note that, software or firmware is described as a program and stored in a memory 304.

The processor 303 reads and executes the program stored in the memory 304 to implement the above-described functions of the chirp signal control unit 7 and the phase difference detection unit 8 in the radar device 200, the radar device 201, or the radar device 202.

These programs cause a computer to execute procedures or methods of the chirp signal control unit 7 and the phase difference detection unit 8 in the radar device 200, the radar device 201, or the radar device 202. The memory 304 may be a computer-readable storage medium storing a program for causing a computer to function as the chirp signal control unit 7 and the phase difference detection unit 8 in the radar device 200, the radar device 201, or the radar device 202.

Examples of the memory 304 correspond to a nonvolatile or volatile semiconductor memory, such as a random access memory (RAM), a read only memory (ROM), a flash memory, an erasable programmable read only memory (EPROM), or an electrically-EPROM (EEPROM); a magnetic disk, a flexible disk, an optical disk, a compact disc, a mini disc, and a DVD.

A part of the functions of the chirp signal control unit 7 and the phase difference detection unit 8 in the radar device 200, the radar device 201, or the radar device 202 may be implemented by dedicated hardware, and a part thereof may be implemented by software or firmware.

For example, the function of the chirp signal control unit 7 is implemented by a processing circuit as dedicated hardware. The function of the phase difference detection unit 8 may be implemented by the processor 303 reading and executing a program stored in the memory 304.

Thus, the processing circuit can implement each of the above functions by hardware, software, firmware, or a combination thereof.

It should be noted that the present invention can freely combine the embodiments, modify any constituent element of each embodiment, or omit any constituent element in each embodiment within the scope of the invention.

### INDUSTRIAL APPLICABILITY

The radar device according to the present disclosure can detect a phase difference of a signal between antennas without preparing a reflector, and thus can be used for a technique of correcting the phase difference in the radar device.

### REFERENCE SIGNS LIST

1: REF, 2-1: chirp signal source, 2-2: chirp signal source, 3-1: transmission antenna, 3-2: transmission antenna, 4-1: reception antenna, 4-2: reception antenna, 5-1: mixer, 5-2: mixer, 6-1: analog-to-digital converter, 6-2: analog-to-digital converter, 7: chirp signal control unit, 8: phase difference detection unit, 9-1: chirp signal source, 9-2: chirp signal source, 9a-1: transmission chirp signal source, 9a-2: transmission chirp signal source, 9b-1: mixing chirp signal source, 9b-2: mixing chirp signal source, 10-1: phase shifter, 10-2: phase shifter, 101-1: first module, 101-2: second module, 102-1: first module, 102-2: second module, 103-1: first module, 103-2: second module, 200, 201, 202: radar device, 300: processing circuit, 301: plurality of modules, 302: reference clock generation device, 303: processor, 304: memory

1. A radar device comprising a plurality of modules, each of the plurality of modules including a chirp signal source, a transmission antenna, a reception antenna, a mixer, and an analog-to-digital converter, wherein
the chirp signal source generates a chirp signal,
the transmission antenna transmits the chirp signal generated by the chirp signal source,
the reception antenna directly receives chirp signals transmitted by transmission antennas of modules other than a module to which the reception antenna belongs among the plurality of modules,
the mixer generates a baseband signal by mixing the chirp signal generated by the chirp signal source and the chirp signals received by the reception antenna, and
the analog-to-digital converter generates a digital signal by digital-converting the baseband signal generated by the mixer, further comprising
a chirp signal controller to perform control so that the chirp signal sources of the plurality of modules generate chirp signals each having a chirp start timing different from each other: and
a phase difference detector to identify a module of a signal source of a chirp signal on which a digital signal generated by the analog-to-digital converter is based, by detecting a frequency difference of the chirp signal between modules, the frequency difference being generated by the control by the chirp signal controller, on a basis of the digital signal.

2. The radar device according to claim 1, wherein the mixer is an image rejection mixer.

3. The radar device according to claim 1, wherein
each of the plurality of modules further includes a phase shifter,
the phase shifter performs phase modulation on the chirp signal generated by the chirp signal source, and
the chirp signal controller further performs control so that the phase shifters of the plurality of modules perform phase modulation using code sequences different from each other.

4. A radar device comprising a plurality of modules, each of the plurality of modules including a chirp signal source, a transmission antenna, a reception antenna, a mixer, and an analog-to-digital converter, wherein
the chirp signal source generates a chirp signal,
the transmission antenna transmits the chirp signal generated by the chirp signal source,
the reception antenna directly receives chirp signals transmitted by transmission antennas of modules other than a module to which the reception antenna belongs among the plurality of modules,
the mixer generates a baseband signal by mixing the chirp signal generated by the chirp signal source and the chirp signals received by the reception antenna, and
the analog-to-digital converter generates a digital signal by digital-converting the baseband signal generated by the mixer, wherein
the chirp signal source includes a transmission chirp signal source to generate a transmission chirp signal and a mixing chirp signal source to generate a mixing chirp signal,
the transmission antenna transmits the transmission chirp signal generated by the transmission chirp signal source,
the reception antenna directly receives transmission chirp signals transmitted by transmission antennas of modules other than a module to which the reception antenna belongs among the plurality of modules, and
the mixer generates a baseband signal by mixing the mixing chirp signal generated by the mixing chirp signal source and the transmission chirp signals received by the reception antenna.

5. The radar device according to claim 4, further comprising a chirp signal controller to perform control so that the transmission chirp signal sources of the plurality of modules generate transmission chirp signals each having at least one of a chirp start timing and a frequency different from each other.

6. The radar device according to claim 5, wherein
the plurality of modules include a target transmission module,
a transmission antenna of the target transmission module transmits a transmission chirp signal generated by a transmission chirp signal source of the target transmission module to a target, and
the chirp signal controller performs control so that the transmission chirp signal sources of the plurality of modules generate chirp signals each having at least one of a chirp start timing and a frequency different from each other, and the transmission chirp signal source of the target transmission module generates a chirp signal having a latest chirp start timing among the transmission chirp signal sources of the plurality of modules.
